(19) United States
(12) Patent Application Publication
(10) Pub. No.: US 2005/0212648 A1
(43) Pub. Date: Sep. 29, 2005

(54) Low-capacitance laminate varistor

(75) Inventors: Shih Kwan Liu, Hsinchu City (TW); Hui Ming Feng, Jhongli City (TW)

Correspondence Address: DENNISON, SCHULTZ, DOUGHERTY & MACDONALD, 1727 KING STREET, SUITE 105, ALEXANDRIA, VA, 22314, US

(73) Assignee: INPAQ TECHNOLOGY CO., LTD.

(21) Appl. No.: 10/806,430

(22) Filed: Mar. 23, 2004

(51) Int. Cl. H01C 7/10

(52) U.S. Cl. 338/21; 338/20

(57) ABSTRACT

A low-capacitance laminate varistor has at least one pair of first and second inner electrodes; a varistor layer, formed by at least one pair of first and second outer electrodes and the varistor layer being laminated; and the first outer electrode and the second outer electrode are electrically connected to the first inner electrode and a second inner electrode, respectively. In the low-capacitance laminate varistor of the present invention, the first inner electrode and the second inner electrode are staggered and also formed on the same plane and parallel to one another so that the electrode surface of the first inner electrode does not face the electrode surface of the second inner electrode.

### BACKGROUND OF THE INVENTION

1. Field of the Invention

The present invention relates to a low-capacitance laminate varistor adapted for being incorporated into a low-capacitance high-frequency circuit, or a new structure of laminate varistor of like technology.

2. Description of the Prior Art

Conventionally, as shown in FIG. 5, a laminate varistor is configured in the following manner. That is, at least two paired inner electrodes 20a and 20b and a varistor layer 21 are laminated. Moreover, ceramic layers 22 and 23 are provided as outermost layers for protecting the laminate. The inner electrodes 20a and 20b are electrically connected to outer electrodes 24 and 25 respectively. The varistor layer 21 has a dielectric constant. The surfaces W at the ends of the inner electrodes 20a and 20b are separated from the varistor layer 22 and face one another. (Please refer to unexamined Japanese Patent Publication (kokai) Nos. Hei. 5-6806 and Hei. 5-6807).

Similarly, conventionally, also in the case where a plurality of inner electrodes 30a, 30b; 31a, 31b; . . . are provided in a laminate varistor as shown in FIG. 6. The laminate varistor is configured in the following manner. That is, the inner electrodes 30a, 30b; 31a, 31b; . . . are formed so that the surfaces of inner electrode at length W of inner electrodes 30a, 30b; 31a, 31b face the varistor layer 32a, 32b . . . respectively. Protection ceramic layers 33 and 34 are provided as outermost layers. The inner electrodes 30a, 30b; 31a, 31b; . . . are electrically connected to outer electrodes 35 and 36 respectively (Please refer to unexamined Japanese Patent Publication (kokai) Nos. Hei. 5-283208 and Hei. 8-55710).

In the laminate varistor configured as described above, the capacitance increases as the facing surfaces W of the inner electrodes 20a, 20b, 30a, 30b, 31a, 31b . . . increase in terms of areas. However, if the capacitance is large, a high-frequency signal may be passed through the varistor or the waveform of the signal can be distorted in the case where the varistor is used in a high-frequency circuit. To prevent this problem, it is necessary to set the capacitance to a value of about several tens of pF (picofarad). In the aforementioned configuration, however, it is difficult to set the capacitance to a value of about several tens of Pf (picofarad).

### SUMMARY OF THE INVENTION

It is an object of the present invention to provide a low-capacitance laminate varistor in which varistor capacitance can be set to a small value while a varistor voltage is kept in a value equivalent to that of a conventional varistor.

A laminate varistor according to the present invention comprises at least one pair of first and second inner electrodes; a varistor layer, formed by at least one pair of first and second inner electrodes and the varistor layer being laminated; and, a first outer electrode and a second outer electrode electrically connected to the first inner electrode and a second inner electrode, respectively, wherein the first inner electrode and the first inner electrode are on the same plane and parallel to each other so that the electrode surface of the first inner electrode does not face the electrode surface of the second inner electrode.

A laminate varistor according to the present invention comprises: a ceramic sintered body comprising at least one pair of first and second inner electrodes; a varistor layer, formed by at least one pair of first and second outer electrodes and the varistor layer being laminated; and protection ceramic layers as outermost layers of the ceramic sintered body; and a first outer electrode and a second outer electrode electrically connected to the first inner electrode and a second inner electrode, respectively; wherein a width of the ceramic sintered body can be shorter than, equal to or longer than the sum of the lengths of the first and second inner electrodes.

### BRIEF DESCRIPTION OF THE DRAWINGS

A more complete understanding of these and other features and advantages of the patent invention will become apparent from a careful consideration of the following detailed description of certain embodiments illustrated in the accompanying drawings.

FIG. 1 is a cross-sectional view showing a low-capacitance laminate varistor according to an embodiment of the present invention;

FIG. 2 is a cross-sectional view showing a low-capacitance laminate varistor according to another embodiment of the present invention;

FIG. 3A is a cross-sectional view showing a low-capacitance laminate varistor according to a further embodiment of the present invention;

FIG. 3B is a cross-sectional view showing a low-capacitance laminate varistor of a modified embodiment of the embodiment shown in FIG. 3A;

FIG. 3C is a cross-sectional view showing a low-capacitance laminate varistor of another modified embodiment of the embodiment shown in FIG. 3A;

FIG. 3D is a cross-sectional view showing a low-capacitance laminate varistor of a further modified embodiment of the embodiment shown in FIG. 3A;

FIG. 4 is a perspective view showing the structure of an inner electrode;

FIG. 5 is an explanatory view showing a laminate varistor as a conventional example; and

FIG. 6 is an explanatory view showing a laminate varistor as another conventional example.

### DETAILED DESCRIPTION OF THE PREFERRED EMBODIMENTS

The present invention will be described in detail below with reference to the accompanying drawings. Each of the laminate varistors shown in the drawings is configured in the following manner. That is, ceramic green sheets are formed from a ceramic material containing ZnO as a main component. Electric-conductive paste of Pd, Ni, Ag—Pd, or the like, is printed on each of the ceramic green sheets to form inner electrodes. The ceramic green sheets are laminated and baked to obtain a ceramic sintered body having protection ceramic layers as outermost layers. Then, Ag or Cu baked layers are plated with Ni, Sn, solder, or the like, to thereby provide outer electrodes on outer surfaces of the ceramic sintered body so that finally, the outer electrodes are electrically connected to the inner electrodes. Then, the low-capacitance laminate varistor of present invention is obtained.

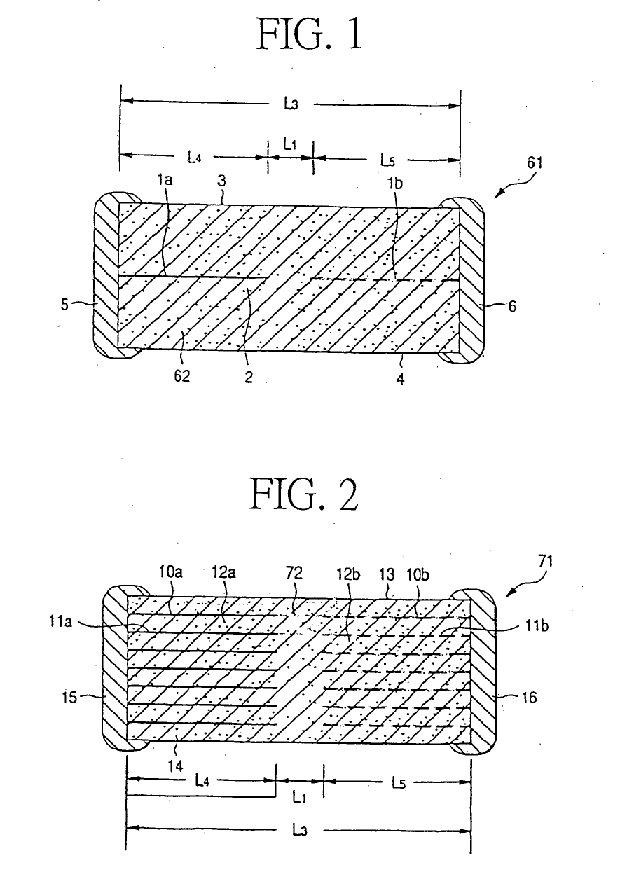

A low-capacitance laminate varistor 61 of the present invention as shown in FIG. 1 is configured in the following manner. That is, two inner electrodes, a first inner electrode 1a and a second inner electrode 1b, making a pair to each other, are staggered and also formed on the same plane and parallel to one another so that the electrode surface of the first inner electrode does not face the electrode surface of the second inner electrode. A varistor layer 2 are laminated and baked to thereby obtain a ceramic sintered body 62 having protection ceramic layers 3 and 4 as outermost layers. The first and second inner electrodes 1a and 1b are also electrically connected to first and second outer electrodes 5 and 6, respectively.

A low-capacitance laminate varistor 71 of the present invention as shown in FIG. 2 has a plurality of pairs of first and second inner electrodes 10a, 10b; 11a, 11b; . . . This laminate varistor construction is configured in the following manner. That is, a plurality of varistor layers 12a, 12b . . . and protection ceramic layers 13 and 14 as outermost layers are laminated and baked to thereby obtain a ceramic sintered body 72. First and second outer electrodes 15 and 16 are provided so as to be electrically connected to the pairs of the first and second inner electrodes 10a, 10b; 11a, 11b; . . . . In the case where about six layers are to be laminated as the varistor layers in the multilayer-structure laminate varistor 71, each layer can be formed to have a thickness of about 60 μm.

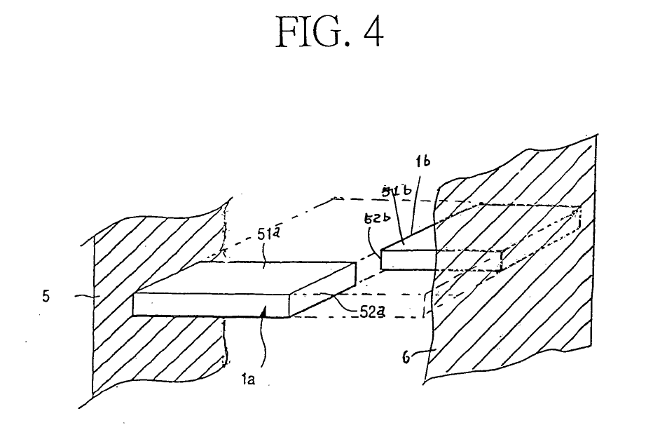

In the laminate varistors 61, 71 shown in FIGS. 1 and 2, the first and second inner electrodes 1a, 1b; 10a, 10b; 11a, 11b; . . . each making a pair of each other, are staggered and also formed on the same plane and parallel to one another so that the electrode surface of the first inner electrode does not face the electrode surface of the second inner electrode, and are separated by a predetermined distance L1 from each other so that the respective pairs of the first and second inner electrodes 1a, 1b; 10a, 10b; 11a, 11b; . . . are formed respectively on the same planes which are the varistor layers 2; 12a; 12b; . . . so that the pairs of the first and second inner electrodes have no surfaces overlapping each other. For example, as shown in FIG. 4, the inner electrode 1a(1b) has an electrode surface 51a, 51b and a tip end surface 52a, 52b. In this case, the electrode surface 51a of the first inner electrode 1a does not face to that of the second inner electrode 1b. In the laminate varistors 61, 71, the varistor voltage and capacitance are affected by the distance L1 by which the pairs of the first and second inner electrodes 1a, 1b; 10a, 10b; 11a, 11b; . . . are separated from each other. For example, when the varistor voltage is 12 V, the separation distance L1 may be set to about 66 μm. For example, when the varistor voltage is 27 V, the separation distance L1 may be set to about 120 μm.

As shown in FIG. 1, a width L3 of the ceramic sintered body 62 is longer than the sum of a length L4 of the first inner electrode 1a and a length L5 of the second inner electrode. Preferably, the width L3 is from more than 0 to not more than 800 μm. In the present invention, the distance L1 is preferably not more than half of the width L3. These relationships among the lengths, width and distance is also applied to the ceramic sintered body 72 as shown in FIG. 2.

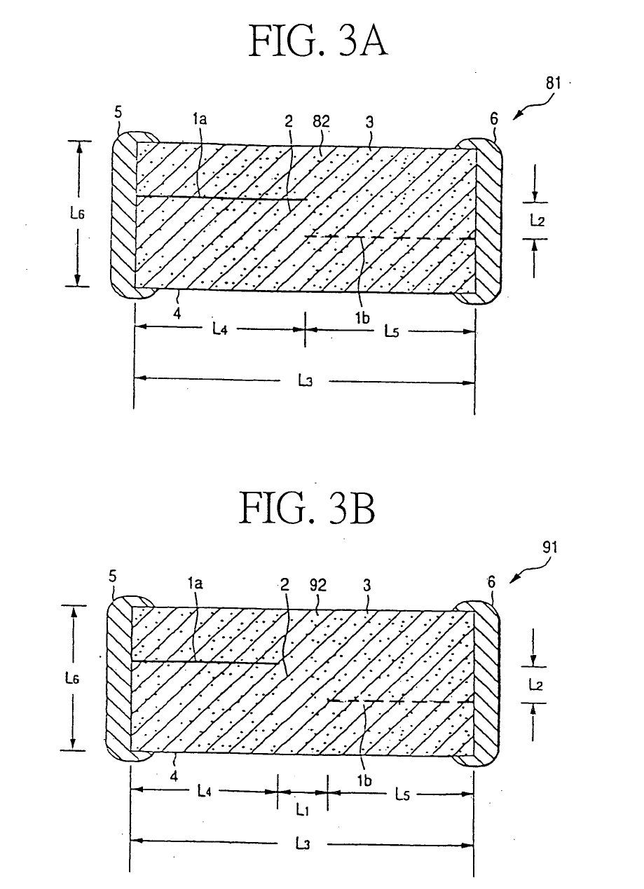

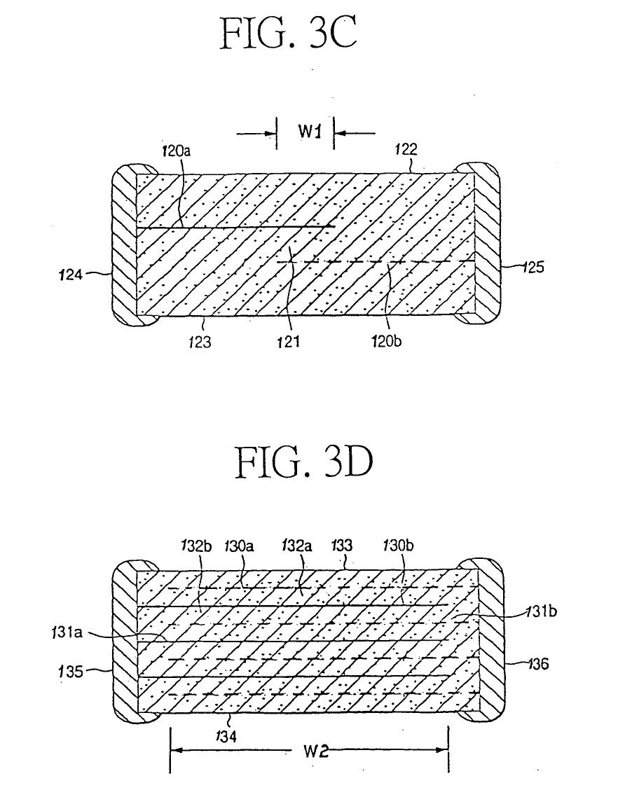

Besides the case where the pairs of first and second inner electrodes 1a, 1b; 10a, 10b; 11a, 11b; . . . are formed respectively on the same planes which are the varistor layers 2, 12a, 12b . . . For example, the inner electrodes 1a and 1b making a pair to each other may be separated from each other by a predetermined separation distance L2 in the thickness direction as seen in the laminate varistor 81 shown in FIG. 3A so that the first and second inner electrodes 1a and 1b are disposed in different planes separated by the varistor layer 2, but they are formed as inner electrodes having no surfaces facing each other in this case, the separation distance L2 by which the first and second inner electrodes 1a and 1b are separated from each other, can be secured by the distance between the inner ends where the first and second inner electrodes 1a and 1b do not face each other and the thickness of the varistor layer 2 interposed between the first and second inner electrodes 1a and 1b.

Further, in addition to the embodiment shown in FIG. 3A, it is possible to form the distance L1 between the first and second inner electrodes 1a and 1b, in the varistor as shown in FIG. 3B. The lengths, thickness and distance relationships of FIGS. 1 and 3A can also be applied to a ceramic sintered body 92 of a varistor 91 as shown in FIG. 3B.

In case of FIGS. 3A and 3B, a thickness L6 of the ceramic sintered body is preferably from not less than 0 to not more than 800 μm. The distance L2 is less than the thickness L6. Further, in this case, the width L3 is equal to or longer than the sum of the length L4 of the first inner electrode 1a and the length L5 of the second inner electrode 1b.

As shown in FIG. 3C, two paired inner electrodes 120a and 120b can be formed on different planes. Because the two inner electrodes are staggered to each other, if it is seen from cross-section, although two inner electrodes are overlapped at a length W₁, however, the inner electrodes 120a, 120b do not face each other. Similarly, as shown in FIG. 3D, the inner electrodes can be a plurality of 130a, 130b; 131a, 131b; . . . The plurality of inner electrodes are all staggered to each other.

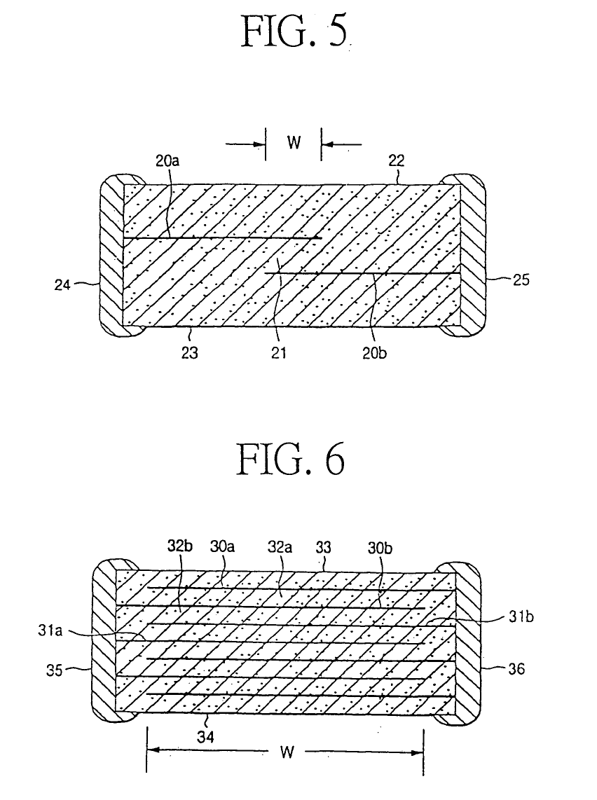

In comparison with the characteristic of conventional laminate varistors having 1 varistor layer and 6 varistor layers, respectively shown in FIG. 5 and FIG. 6, with the present invention's laminate varistors 1 varistor layer, 6 varistor layers respectively shown in FIG. 1 and FIG. 2. It can be understood that the capacitance (pF) of present invention was reduced extremely in comparison with that of the conventional laminate varistor. Also the withstand electrostatic voltage resistance measured in terms of the rate of the change of the varistor voltage after 100 times repetition of a pulse of 30 KV was substantially equivalent to or better than that of the conventional laminate varistor.

Further, because the varistor voltage is determined by the separation distance by which the inner electrodes are separated from each other. Accordingly, a laminate varistor having a target characteristic can be obtained easily if the separation distance and the total number of varistor layers are adjusted in accordance with the required value of capacitance. Incidentally, the baking temperature in the present invention is set to be more or less higher than that in the conventional case. This is because the number of varistor layers is increased in number by space for separating the inner electrodes from each other are interposed.

As described above, in the low-capacitance laminate varistor according to the present invention, inner electrodes making a pair to each other are separated from each other and thus staggered each other so that the inner electrodes are formed to have no electrode surfaces facing each other. Accordingly, the capacitance can be set to a small value while the voltage is kept in a value equivalent to that of the conventional laminate varistor. Even in the case where the varistor according to the present invention is used in a high-frequency circuit, the high-frequency signal can be prevented from passing through the varistor or the waveform of the signal can be prevented from being distorted. Further, because the varistor voltage can be determined by the separation distance by which the inner electrodes are separated from each other, a laminate varistor having a target characteristic can be obtained easily if the separation distance and the total number of varistor layers are adjusted in accordance with the required value of capacitance.

Although the present invention has been described with a certain degree of particularity, the present disclosure has been made by way of example and changes in details of structure may be made without departing from the spirit thereof.

1. A low-capacitance laminate varistor comprising:
at least one pair of first and second inner electrodes each having a first end and an opposing second end;
a varistor layer, and
a first outer electrode and a second outer electrode, electrically connected to said first inner electrode first end and said second inner electrode first end, respectively;
wherein said first inner electrode and said second inner electrode are dimensioned and configured on a same plane wherein said opposing second end of said first inner electrode and said opposing second end of said second inner electrode are in a non-facing relation to one another and are laterally displaced from one another.

2. The low-capacitance laminate varistor according to claim 1, wherein said first and second electrodes of said pair are separated by varistor layer and formed on different planes.

3. The low-capacitance laminate varistor according to claim 1, wherein said pair of first and second inner electrodes formed on one and the same plane of said varistor layer are in multiples.

4. The low-capacitance laminate varistor according to claim 2, wherein said pair of first and second inner electrodes formed on one and the same plane of said varistor layer are in multiples.

5. The low-capacitance laminate varistor according to claim 1, wherein the length of said pair of first and second inner electrodes is greater, equal to, or smaller than the width of varistor layer.

6. The laminate varistor according to claim 2, wherein the length of said pair of first and second inner electrodes is greater, equal to, or smaller than time width of varistor layer.

7. The laminate varistor according to claim 5, wherein tile length of said pair of first and second inner electrodes is greater, equal to, or smaller than the width of varistor layer.

8. The laminate varistor according to claim 6, wherein the length of said pair of first and second inner electrodes is greater, equal to, or smaller than the width of varistor layer.
